(19) United States
(12) Patent Application Publication
(10) Pub. No.: US 2006/0287959 A1
(43) Pub. Date: Dec. 21, 2006

(54) Software license manager employing license proofs for remote execution of software functions

(75) Inventor: Carsten Blecken, Mountain View, CA (US)

Correspondence Address: PATENT DEPARTMENT;MACROVISION CORPORATION, 2830 DE LA CRUZ BLVD., SANTA CLARA, CA, 95050, US

(73) Assignee: Macrovision Corporation

(21) Appl. No.: 11/156,104

(22) Filed: Jun. 17, 2005

(51) Int. Cl. G06F 17/60

(52) U.S. Cl. 705/59

(57) ABSTRACT

A user of a local computer requests that a remote computer run a software function of an application program by sending the request along with a license proof demonstrating that the local computer is authorized to run the software function using their respective license management software. Upon verifying the source, confirming that it has the right to run the software function, and verifying that the request is timely made, the license management software on the remote computer allows a user on that computer to run the software function as requested.

### FIELD OF THE INVENTION

The present invention generally relates to software license managers and in particular, to a software license manager employing license proofs for remote execution of software functions.

### BACKGROUND OF THE INVENTION

Software license managers control the usage of application programs (i.e., software) so that they may be used only as authorized. A common type of software license manager keeps track of the number of copies of an application program that are concurrently being used in a network, and limits such usage to a maximum number determined by the number of floating licenses purchased for the network.

FIGS. 1 and 2 respectively illustrate a computer network in which such floating licenses are managed, and the software that manages them. In this example, the network includes client computers 110, 120 and 130, and a license server 140 that is connected to the client computers through a local area network 150.

A copy of an application program may be installed on each of the client computers, and optionally, also on the license server. Examples of three such copies are shown as application program copies 211, 221 and 231. A license manager 241 and a vendor supplied license certificate 242 are installed on the license server 140 so that the number of copies concurrently running in the network is restricted by the license manager 241 to the number of floating licenses purchased for the network as indicated along with other license related information in the license certificate 242.

Each copy of the application program is equipped with a license manager interface that communicates with the license manager 241 so that the license manager 241 may control user access to the copy. Thus, for example, when a user tries to run application program copy 211, its license manager interface 212 transmits the user's request to the license manager 241, which either grants or denies the request depending upon whether or not granting the request would cause the number of concurrently running copies of the application program to exceed the number of authorized floating licenses.

Although such a floating license management scheme has proven to be useful and effective when the application program is run in a single process space, it may be improved upon when the application program is to run in a multi-process space or a distributed processing environment such as in the emerging world of web services and service-oriented architecture (SOA).

### OBJECTS AND SUMMARY OF THE INVENTION

Accordingly, it is an object of one or more aspects of the present invention to provide a software license management scheme that is suitable for a distributed processing environment.

In such an environment, an improved licensing scheme is advantageous wherein a license to operate the application program is subdivided into transferable sublicenses to run individual software functions of the application program. Using this scheme, one computing entity may check-out a license for an application program (i.e., receive authorization from its local license manager to run the application program), run one software function of the application program under the authority of a corresponding sublicense of the checked-out license, and transfer a sublicense to run another software function to another computing entity so that the other computing entity may run the other software function under the authority of the transferred sublicense. Thus, the two computing entities in this case may share the same checked-out license while running different software functions of the application program in different processing spaces. The distributed processing may further be extended by transferring additional sublicenses to other computing entities so that even more computing entities may concurrently be executing different software functions under the authority of the same checked-out license.

Another object of one or more aspects of the present invention is to provide a method and apparatus for providing proof of a license to execute a software function, so that a computing entity requesting another computing entity to execute a software function in a distributed processing environment can prove to the other computer entity that it has already checked-out a license to run the software function.

Another object of one or more aspects of the present invention is to provide a method and apparatus for confirming that a remote entity has a license to execute a software function, so that a computing entity receiving a request from another computing entity to run a software function as part of a distributed processing activity can confirm that the other computing entity has already checked-out a license to run the software function and therefore, is entitled to have the software function executed for it.

Still another object of one or more aspects of the present invention is to provide a method and system for executing a software function using the same license in a distributed process spanning different process spaces, so that any computing entity participating in the distributed process may execute the software function without having to check-out another license to do so.

These and additional objects are accomplished by the various aspects of the present invention, wherein briefly stated, one aspect is a method for managing software licenses in a distributed process, comprising: checking out a license to execute a plurality of software functions of an application program; generating a license proof for one of the plurality of software functions; and providing the license proof along with a request to execute the one of the plurality of software functions.

Another aspect is a method for providing proof of a license to execute a software function, comprising: generating a license proof including information from a license authorizing execution of a software function; and providing the license proof along with a request to execute the software function.

Another aspect is an apparatus for providing proof of a license to execute a software function, comprising a processor configured to: generate a license proof including information from a license authorizing execution of a software function; and provide the license proof along with a request to execute the software function.

Another aspect is a method for confirming that a remote entity has a license to execute a software function comprising: receiving a license proof along with a request to execute a software function from a remote entity; and verifying that the license proof came from the remote entity and indicates an authorization to execute the software function.

Another aspect is an apparatus for confirming that a remote entity has a license to execute a software function comprising a processor configured to: receive a license proof along with a request to execute a software function from a remote entity, and verify that the license proof came from the remote entity and indicates an authorization to execute the software function.

Still another aspect is a method for executing a software function in a distributed process spanning different process spaces, comprising: executing a first computer program running in a first process space so as to generate a license proof and transmit the license proof along with a request to execute a software function; and executing a second computer program running in a second process space so as to receive the license proof and verify that the license proof was generated by the first computer program and that the license proof includes an authorization to execute the software function.

Yet another aspect is a system for executing a software function in a distributed process spanning different process spaces, comprising: a first computer executing a first computer program running in a first process space so as to generate a license proof and transmit the license proof along with a request to execute a software function; and a second computer executing a second computer program running in a second process space so as to receive the license proof and verify that the license proof was generated by the first computer program and that the license proof includes an authorization to execute the software function.

Additional objects, features and advantages of the various aspects of the present invention will become apparent from the following description of its preferred embodiment, which description should be taken in conjunction with the accompanying drawings.

### BRIEF DESCRIPTION OF THE DRAWINGS

FIG. 1 illustrates a block diagram of a computer network employing a conventional license manager.

FIG. 2 illustrates software modules employed in conventional management of floating licenses.

FIG. 3 illustrates a block diagram of a distributed processing environment utilizing aspects of the present invention.

FIG. 4 illustrates individually sub-licensable software functions of an application program utilizing aspects of the present invention.

FIG. 5 illustrates software modules employed in management of software licenses in a single network, utilizing aspects of the present invention.

FIG. 6 illustrates software modules employed in management of software licenses in a multi-network environment, utilizing aspects of the present invention.

FIG. 7 illustrates items stored in a license proof utilizing aspects of the present invention.

FIG. 8 illustrates a method for generating and transmitting a license proof along with a request to execute a software function, utilizing aspects of the present invention.

FIG. 9 illustrates a method for processing a license proof along with a request to execute a software function, utilizing aspects of the present invention.

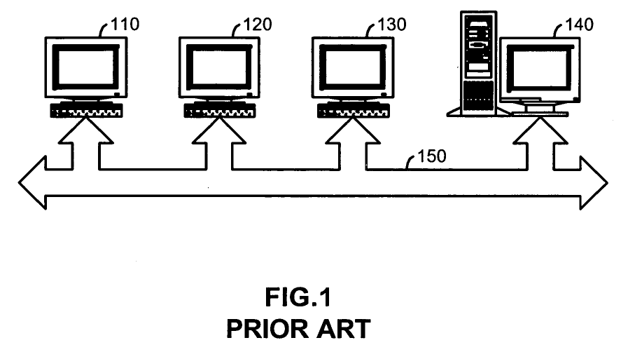

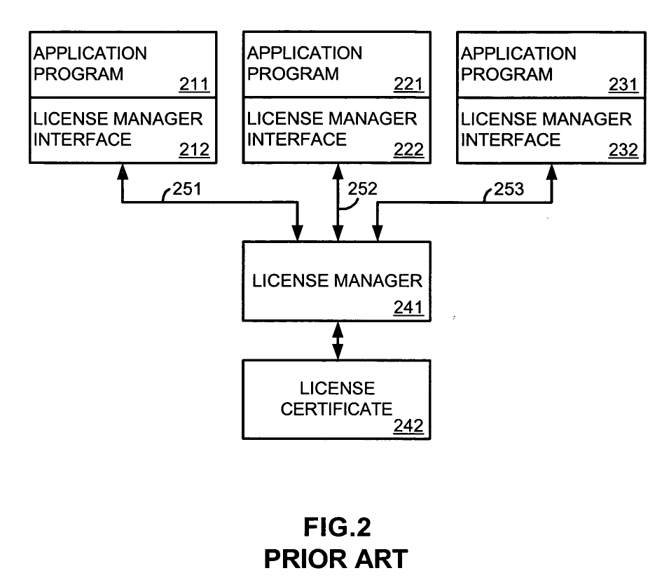

### DETAILED DESCRIPTION OF THE PREFERRED EMBODIMENT

As used herein, the term “compatible license manager” means a license manager that recognizes the sub-licensable and transferable aspects of software functions and manages their usage as described herein, and the term “compatible license manager interface” means a license manager interface that also recognizes the sub-licensable and transferable aspects of software functions and cooperates in the management of their usage with a compatible license manager as described herein.

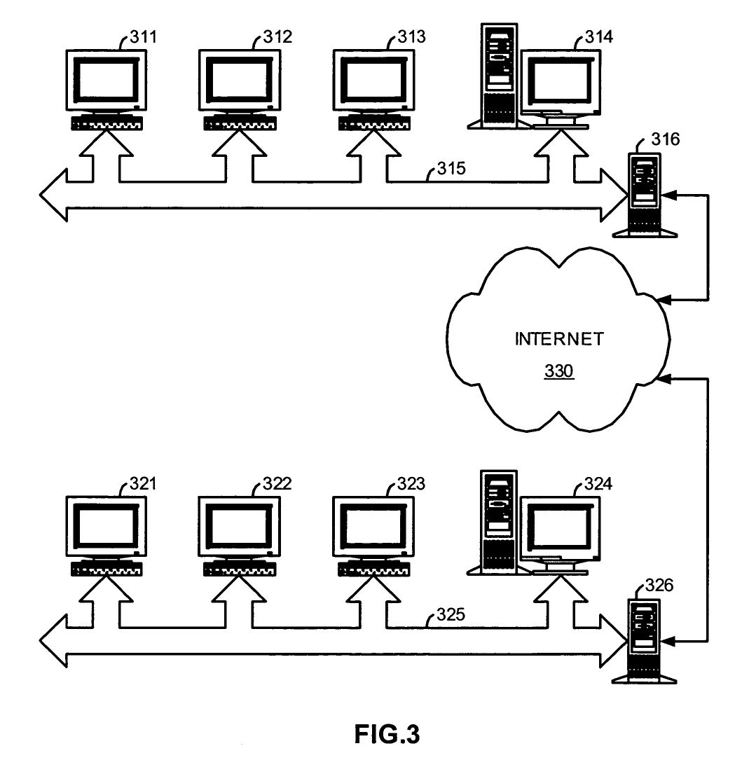

FIG. 3 illustrates, as an example, a block of a distributed processing environment including two networks 315 and 325 which communicate with one another through a communication medium such as the Internet 330. Each of the networks 315 and 325 includes a license server (e.g., license server 314 in network 315, and license server 324 in network 325), a plurality of client computers (e.g., client computers 311-313 in network 315, and client computers 321-323 in network 325), and a firewall (e.g., firewall 316 in network 315, and firewall 326 in network 325).

Each of the networks 315 and 325 may be a local area network or more generally, a group of computers sharing a license server so that a license manager program (“license manager”) running on the license server may manage one or more licensed computer programs (also referred to herein as “application programs”) running on its computers. Also, although only two networks are shown in FIG. 3, it is to be appreciated that an unrestricted number of networks may participate in distributed processing activities and therefore, may be added to the distributed processing environment depicted therein while still being within the contemplated scope of the various aspects of the present invention.

Application programs running on computers in the networks 315 and 325 may be licensed and managed as conventional floating licenses or node locked licenses, with the exception that software functions included in the application programs are sub-licensable and such sublicenses are transferable to other computers or computing entities whose executions of the software functions are managed by compatible license managers.

In the case of a conventional floating license scheme, typically the owner of a network purchases a number of concurrent licenses so that the number of users that are authorized to run the application program in the network at the same time (i.e., concurrently) is limited to that number. In the case of a conventional node locked license, the application program is authorized to only be run or executed on a specified computer. An example of a license manager which manages such floating and/or node locked license usage is FLEXlm™, a product of Macrovision Corporation, Santa Clara, Calif.

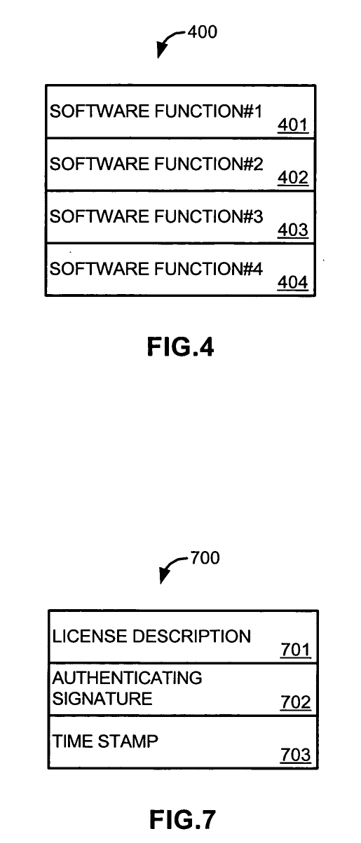

In the license management scheme of the present example, however, the application program includes a plurality of software functions, such as software functions 401-404 illustrated in FIG. 4 which are included the application program 400. Each of the software functions may represent a different feature or different executable module of the application program, and may be sub-licensable so that an authorization to run the software function may be transferred to another computing entity which may then execute the software function under such transferred authority, and under the management of a compatible license manager that authenticates and recognizes the transferred authorization.

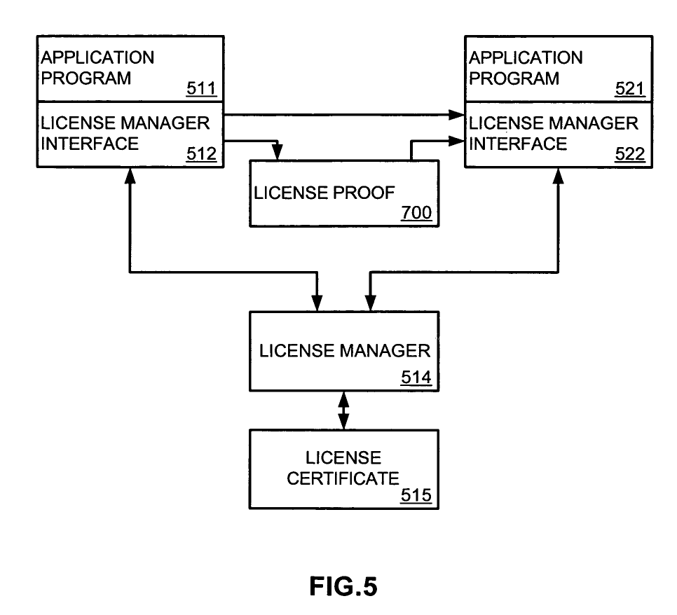

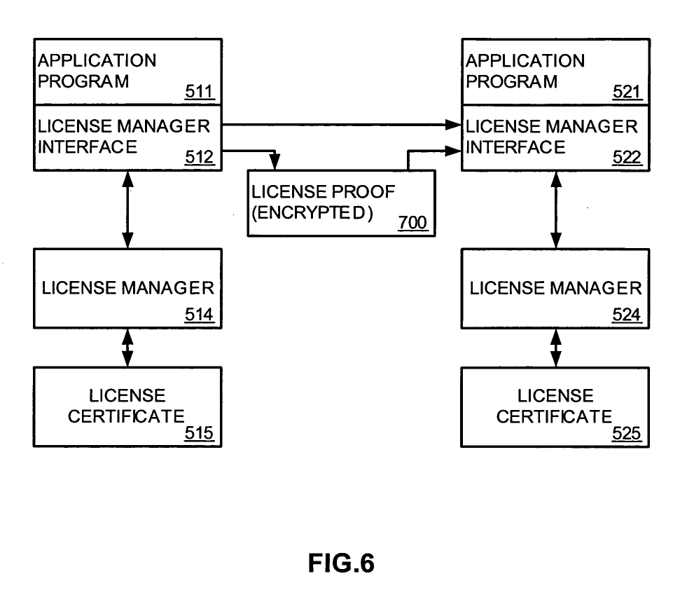

FIGS. 5 and 6 illustrate, as examples, software modules (i.e., computer programs and files/objects) involved in the management of software licenses in a distributed processing environment. FIG. 5 is applicable where two computers in the same network (e.g., client computers 311 and 312 in the network 315) are cooperating in a distributed processing activity, and FIG. 6 is applicable where two computers in different networks (e.g., client computer 311 in the network 315 and client computer 321 in the network 325) are cooperating in a distributed processing activity. Although the term “compatible” is not included in their descriptions, all license managers and license manager interfaces depicted, described and/or referenced in the FIGS. 5-9 are compatible license managers and compatible license manager interfaces.

Common to both FIGS. 5 and 6, a first computing entity such as client computer 311 in network 315 has a copy 511 of the application program 400 installed on it, and its corresponding licenser server such as the license server 314 in network 315 has a license manager 514 and a license certificate 515 installed on it.

The license certificate 515 is generally provided by a vendor of the application program 400, and contains license related information such as the type of software license (e.g., floating or node locked), the number of concurrent users allowed on a specified network (for a floating license) or the identification of one or more computers authorized to run the application program (for a node locked license), the vendor name of the application program, the version or revision number of the application program, an expiration date of the license, an indication of the software functions included in the license (e.g., any or all of software functions 401-404 of the application program 400), and an authenticating signature that authenticates the license certificate 515 as coming from the vendor.

User access to the copy 511 of the application program 400 is controlled by the license manager 514 through a license manager interface 512 which is attached to the copy 511. When the user of the client computer 311 attempts to run the copy 511 of the application program 400, the license manager interface 512 transmits the run request to the license manager 514. Communications between the license manager interface 512 and the license manager 514 are preferably secure, and involve conventional authentication techniques to prevent unauthorized usage of the copy 511.

Upon receiving the run request, the license manager 514 reads the license certificate 515, and determines whether the terms of the software license specified therein allow the user to run the copy 511 at that time. For example, if the license terms specify a floating license with a maximum number of concurrent users, then the license manager 512 determines whether that number would be exceeded if the run request received from the client computer 311 would be granted. If the number would be exceeded, then the request is denied, and the user will have to wait until another user in the network 315 stops running his/her copy of the application program 400. On the other hand, if the number would not be exceeded, then the request is granted, and the user is allowed to run the copy 511 of the application program 400.

Granting of the run request by the license manager 514 for running the copy 511 is referred to as “checking-out” a license, since the grant can be thought of as reducing the number of available licenses by one. When the user subsequently stops running the copy 511, the license manager interface 512 notifies the license manager 514 of this action so that it may increment the number of available licenses. This reverse process is referred to as “checking-in” the license.

Whether the license terms specify a floating license or a node locked license, the handling of the request by the license manager 514 is substantially the same as performed by prior art license managers. In this case, checking-out a license means that all licensed software functions of the application program 400 (as indicated in the license certificate 515) are authorized to be run by the run requesting client computer 511. In particular, if only software functions 401-403 are licensed, and not software function 404, then software functions 401-403 are checked-out by the client computer 311 upon being granted its run request.

Each of the licensed software functions are sub-licensable and such sublicenses are transferable to other computing entities, so that if the client computer 311 (referred to as the “license proof provider” or simply, “provider” in this case) requests another computing entity such as client computer 312 in its network 315 or client computer 321 in the network 325 (referred to as the “license proof acceptor” or simply, “acceptor” in this case) to run one of the licensed software functions, it is free to do so using the software licensing mechanism described herein.

In order to prove that it has the authorization to have another computing entity run the software function, the client computer 311 (the “provider”) generates a license proof 700 that it sends along with the request to execute the licensed software function to the other computing entity (the “acceptor”). Preferably, the license proof 700 is generated as a data object having a representation which can be easily transmitted or serialized such as in a programming language neutral XML representation.

FIG. 7 illustrates, as an example, items included in the license proof 700. Included in the license proof 700 is a section for a license description 701, and fields for an authenticating signature 702 and a time stamp 703. The license description 701 includes license related information for an application program such as the name of its vendor, its version or revision number, identification of the software functions of the application program that are included in the license, and the expiration date of the license. The authenticating signature 702 is a vendor provided signature that authenticates an item as being authorized by or coming from the vendor. The time stamp 703 is a time/date that a license was checked-out for use from a license manager.

The license description 701 and the authenticating signature 702 are provided to the license manager interface 512 by the license manager 514 from the license certificate 515. The time stamp 703 is also preferably provided to the license manager interface 512 by the license manager 514 to indicate when the license to run the copy 511 was checked-out. Alternatively, the time stamp may be determined by the license manager interface 512 at the time it receives authorization from the license manager 514 to run the copy 511 using a conventional time/date function running on the client computer 311.

Following is an example of an unencrypted license proof using a flat text representation similar to the representation of the license rights:

ComputingFeature mvsn 1.0 1-jun-2005 HOSTID=DEMO SIGN=”
1F54 E53F A55A B233 C75B E7EE 1088 3FD3 E114 92FF C1A0 8F0E
11AB 530D F36B 1752 3D5E 761F 66EF 1672 85A3 6028 A113 2668
0CDC 4CBB 686F 0065 F3D4 986C” TIMESTAMP=”26 Aug 2004
23:51:12 GMT”.

The request to run the software function and the license proof 516 is preferably communicated through the license manager interfaces of the license proof provider and the license proof acceptor computing entities (e.g., license manager interfaces 512 and 522). When the acceptor receives the request and the license proof 700, its license manager interface 522 preferably passes the license proof to its license manager (e.g., 514 of FIG. 5 if the acceptor is in the same network as the provider, or 524 of FIG. 6 if the acceptor is in a different network than the provider) which authenticates the authenticating signature 702 to confirm that the license proof 700 has been properly authorized, verifies that the license proof provider has the authority to run the requested software function according to the license description 701, and verifies that the license has been checked-out reasonably recently according to the time stamp 703. If all of these conditions are satisfied, then the license manager authorizes the license manager interface 522 to run the requested software function under the authority of the license proof 700 without checking-out another license to do so.

For security purposes, it may be desirable for the client computer 311 to encrypt at least the license proof 700 before sending it along with the request to run a software function to another client computer. Prevention of license proof misappropriation or tampering is especially a concern when information is being transmitted over the Internet.

By encrypting the license proof using a shared secret key only known by compatible license manager interfaces (e.g., license manager interfaces 512 and 522) and/or compatible license managers (e.g., license managers 514 and 524), the source of the communication can be authenticated (i.e., that it comes from a compatible license manager interface), the communication is protected against tampering, and its misappropriation is discouraged.

Alternatively, by encrypting the license proof using the private key associated with a provider so that it can be decrypted at the receiving end using the public key associated with the provider, the source of the communication can be authenticated (i.e., that it comes from the provider), the communication is protected against tampering, and its misappropriation is discouraged.

Although it may be feasible for the license manager 514 of a license proof provider in one network (e.g., network 315) to interact directly with the license manager interface 522 of a license proof acceptor in another network (e.g., network 325) so that the arrangement depicted in FIG. 5 may be used even in that case, communications between the two modules in such an arrangement may be complicated when firewalls exist in the networks (e.g., firewall 316 in network 315, and firewall 326 in network 325). Therefore, to avoid having a license manager and a license manager interface communicate through firewalls, the arrangement depicted in FIG. 7 is preferred in such a case.

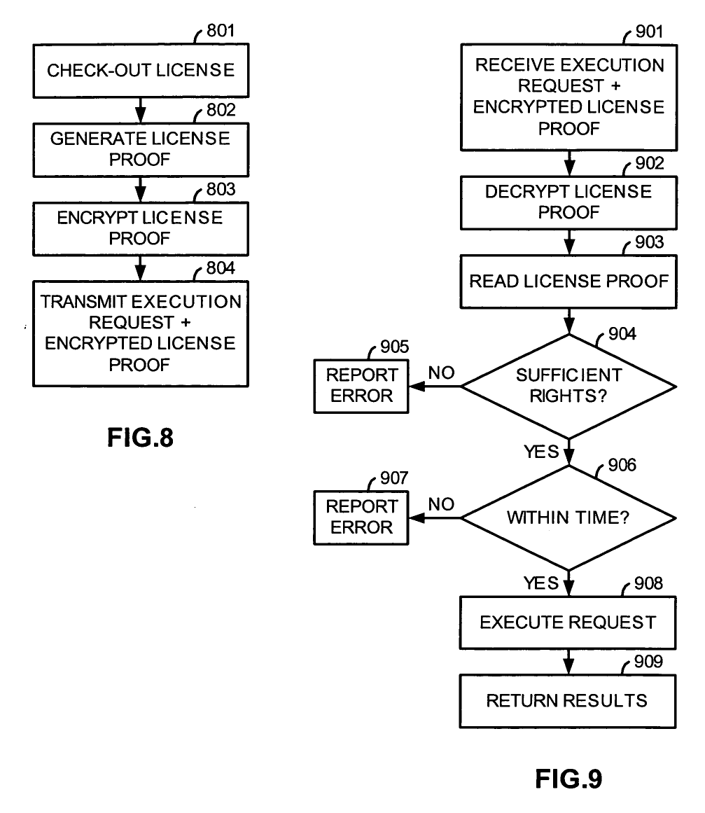

FIGS. 8 and 9 illustrate, as examples, the methods or processes performed at the transmitting and receiving computing entities so as to further elaborate on the software licensing scheme described above.

Referring to FIG. 8, in 801, a client computer (e.g., 311) checks out a license to run a copy (e.g., 511) of an application program (e.g., 400) by a user attempting to run it or otherwise making a request to do so, and a license manager (e.g., 514) allowing the user to run the copy according to license terms read from a vendor supplied license certificate (e.g., 515).

In 802, when the user initiates a request for another computing entity (e.g., 312 in the same network or 321 in a different network) as part of a distributed processing activity to run a software function included as part of the application program, a license manager interface (e.g., 512) attached to the copy of the application program generates a license proof 700 from information provided by the license manager, preferably including a license description 701, an authenticating signature 702, and a time stamp 703.

In 803, the license manager interface encrypts the license proof using either a shared secret key or a private key uniquely associated with the license manager interface, and in 804, the license manager interface sends the run request (for the specified software function) along with the encrypted license proof to a compatible license manager interface (e.g., 522) installed on the other computing entity.

At this point, the license manager interface preferably prevents the user from running the software function, since his or her right to do so has now been transferred to the other computing entity (the license proof acceptor). After the other computing entity has run the software function as requested, the user may run the software function provided the other computing entity returns the license proof, or otherwise indicates that it is finished using it, to the license manager interface associated with the user.

Referring to FIG. 9, in 901, the license manager interface (e.g., 522) of the other computing entity (e.g., 312 or 321) receives the software function run request and the encrypted license proof (e.g., 516) from the requesting computing entity (e.g., 311).

In 902, the license manager interface preferably sends the encrypted license proof to its license manager for processing (e.g., license manager 515 if the other computing entity is on the same network as the requesting computing entity, or license manager 525 if the other computing entity is on a different network as the requesting computing entity and therefore, is managed by a different license manager), and the license manager decrypts the encrypted license proof.

Decryption in this case may be performed, for example, using a shared secret key if the license proof had been encrypted by the shared secret key, or using a public key associated with the sender of the encrypted license proof (e.g., the license proof provider) if the license proof had been encrypted by the private key of the sender. In any event, the key used to decrypt the encrypted license proof would depend upon the convention used in the particular software license managing scheme, and successful decryption indicates authentication of the source of the encrypted license proof.

In 903, the license manager reads the decrypted license proof, and in 904 and 905 determines whether or not it will allow the computing entity (e.g., the license proof acceptor) to run the software function from its installed copy (e.g., 521) of the application program (e.g., 400).

In 904, the license manager determines whether or not the license proof indicates sufficient rights to have the computing entity run the software function. For example, it may confirm that the software function being requested to be run is a licensed software function. Also, it may verify an authenticating signature read from the license proof as being that of the vendor of the application program (e.g., 400) by comparing it with an authenticating signature for that vendor as found in its license certificate (e.g., license certificate 515 if the license manager 514 is performing this task, or license certificate 525 if the license manager 524 is performing it) for the copy (e.g., 521) of the application program (e.g., 400) that is to be used for running the requested software function. Also, it may determine whether the license described in the license proof has expired, and/or whether it is for the same version or revision of the application program as installed on its computer. If the license manager determines that insufficient rights exist to have the computing entity run the software function, then in 905, it notifies the appropriate license manager interface (e.g., 522) of that fact so that it may send a suitable error report back to its counterpart in the run requesting client computer (e.g., the license proof provider).

In 905, the license manager determines whether or not the license proof has been generated within a reasonably recent or otherwise, predetermined period of time. For example, it may compare the time stamp (e.g., 703) in the license proof 700 against the present time on its system (or time in an agreed upon time zone), and if the difference is greater than a predetermine period of time, such as 48 hours, determine that the license proof is no longer valid. If the license manager determines that the license proof is no longer valid, because it has not been generated within a reasonably recent or otherwise, predetermined period of time, then in 906, it notifies the appropriate license manager interface (e.g., 522) of that fact so that it may send a suitable error report back to its counterpart in the run requesting client computer (e.g., the license proof provider).

On the other hand, if the license manager determines that the license proof indicates sufficient rights to have the computing entity run the software function and the license proof has been generated within a reasonably recent or otherwise, predetermined period of time, then in 908, it notifies the appropriate license manager interface (e.g., 522) of that fact so that it may allow the user of its client computer (e.g., the license proof acceptor) run the requested software function. The results from executing the software function may then be returned to the requesting client computer (e.g., the license proof provider) in 909.

In the examples described above, it has been assumed that only one software function is being requested to be run by another computer in a distributed processing environment. However, in practice, the requesting computer may request another client computer to run more than one software function in one or more distributed processing activities, and such a possibility is fully contemplated to be within the scope of the various aspects of the present invention. Also, it has been assumed that the client computer receiving the run request will actually execute the software function. However, in practice, the license proof acceptor may relay the request to another client computer within its network or even out of it, by simply passing the received license proof and run request to the other client computer, and such a possibility is also fully contemplated to be within the scope of the various aspects of the present invention.

Although the various aspects of the present invention have been described with respect to a preferred embodiment, it will be understood that the invention is entitled to full protection within the full scope of the appended claims.

What is claimed is:

1. A method for managing software licenses in a distributed process, comprising: checking out a license to execute a plurality of software functions of an application program; generating a license proof for one of the plurality of software functions; and providing the license proof along with a request to execute the one of the plurality of software functions.

2. The method according to claim 1, wherein the checking out of the license comprises: requesting a license manager to allow running of the application program.

3. The method according to claim 2, wherein the checking out of the license further comprises: being allowed to run the application program if granting of the request to run the application program does not cause a number of concurrent users running the application program to exceed an authorized number.

4. The method according to claim 1, wherein the plurality of software functions represents features of the application program.

5. The method according to claim 1, wherein the plurality of software functions represents components of the application program.

6. The method according to claim 1, wherein the license proof includes an authenticating signature indicating a right to execute the plurality of software functions.

7. The method according to claim 6, wherein the authenticating signature is copied from a license certificate associated with the application program and provided by a vendor of the application program.

8. The method according to claim 1, wherein the license proof includes a time stamp indicating when the license was checked out.

9. The method according to claim 1, wherein the providing of the license proof comprises: encrypting the license proof to generate an encrypted license proof, and providing the encrypted license proof along with the request to execute the one of the plurality of software functions.

10. The method according to claim 9, wherein the license proof is encrypted using a shared secret key to generate an encrypted license proof so that substantially only an entity in possession of the shared secret key may decrypt the encrypted license proof.

11. The method according to claim 9, wherein the license proof is encrypted using a private key of a sender to generate an encrypted license proof so that decryption of the encrypted license proof using a public key of the sender verifies that substantially only the sender could have generated the encrypted license proof.

12. The method according to claim 1, wherein the license proof is generated as a data object.

13. The method according to claim 1, further comprising: receiving the license proof along with the request to execute the one of the plurality of software functions; verifying the source and authenticity of the license proof; and executing the one of the plurality of software functions under the authority of the license proof.

14. The method according to claim 13, wherein the license proof is received as an encrypted license proof and the verification of the source of the license proof comprises: decrypting the license proof with a secret key only shared with the provider of the encrypted license proof, so that the provider is verified as the source of the license proof upon successful decryption of the encrypted license proof.

15. The method according to claim 13, wherein the license proof is received as an encrypted license proof that has been encrypted with a private key of a provider of the encrypted license proof and the verification of the source of the license proof comprises: decrypting the license proof with a public key of the provider of the encrypted license proof, so that the provider is verified as the source of the license proof upon successful decryption of the encrypted license proof.

16. The method according to claim 13, wherein the license proof includes an authenticating signature copied from a license certificate provided by a vendor of the application program that indicates a right to execute the plurality of software functions, and the authentication of the license proof comprises: verifying the authenticating signature as being genuine.

17. A method for providing proof of a license to execute a software function, comprising: generating a license proof including information from a license authorizing execution of a software function; and providing the license proof along with a request to execute the software function.

18. The method according to claim 17, wherein the license proof includes information from the license indicating which software functions of a computer program are authorized for execution.

19. The method according to claim 18, wherein the software functions indicate features of the computer program.

20. The method according to claim 18, wherein the software functions indicate components of the computer program.

21. The method according to claim 17, wherein the license proof includes an authenticating signature indicating a right to execute the software function.

22. The method according to claim 17, wherein the license proof includes an authenticating signature copied from the license indicating a right to execute the software function.

23. The method according to claim 17, wherein the license proof includes a time stamp indicating when a license managing agent activated the license.

24. The method according to claim 17, further comprising: encrypting the license proof to generate an encrypted license proof, and providing the encrypted license proof along with the request to execute the software function.

25. The method according to claim 24, wherein the license proof is encrypted using a shared secret key to generate an encrypted license proof so that substantially only an entity in possession of the shared secret key may decrypt the encrypted license proof.

26. The method according to claim 24, wherein the license proof is encrypted using a private key of a sender to generate an encrypted license proof so that decryption of the encrypted license proof using a public key of the sender verifies that substantially only the sender could have generated the encrypted license proof.

27. The method according to claim 17, wherein the license proof is generated as a data object.

28. An apparatus for providing proof of a license to execute a software function, comprising a processor configured to: generate a license proof including information from a license authorizing execution of a software function; and provide the license proof along with a request to execute the software function.

29. The apparatus according to claim 28, wherein the license proof includes information from the license indicating which software functions of a computer program are authorized for execution.

30. The apparatus according to claim 29, wherein the software functions indicate features of the computer program.

31. The apparatus according to claim 29, wherein the software functions indicate components of the computer program.

32. The apparatus according to claim 28, wherein the license proof includes an authenticating signature indicating a right to execute the software function.

33. The apparatus according to claim 28, wherein the license proof includes an authenticating signature copied from the license indicating a right to execute the software function.

34. The apparatus according to claim 28, wherein the license proof includes a time stamp indicating when a license managing agent activated the license.

35. The apparatus according to claim 28, wherein the processor is further configured to encrypt the license proof to generate an encrypted license proof, and provide the encrypted license proof along with the request to execute the software function.

36. The apparatus according to claim 35, wherein the license proof is encrypted using a shared secret key so that substantially only an entity in possession of the shared secret key may decrypt the encrypted license proof.

37. The apparatus according to claim 35, wherein the license proof is encrypted using a private key of a sender so that decryption of the encrypted license proof using a public key of the sender verifies that substantially only the sender could have generated the encrypted license proof.

38. The apparatus according to claim 28, wherein the processor is further configured to generate the license proof as a data object.

39. A method for confirming that a remote entity has a license to execute a software function comprising: receiving a license proof along with a request to execute a software function from a remote entity; and verifying that the license proof came from the remote entity and indicates an authorization to execute the software function.

40. The method according to claim 39, further comprising: executing the software function in response to the request after verifying that the license proof came from the remote entity and indicates the authorization to execute the software function.

41. The method according to claim 40, further comprising: transmitting information resulting from executing the software function to the remote entity.

42. The method according to claim 39, wherein the license proof includes information of which functions of a computer program are authorized for execution.

43. The method according to claim 42, wherein the verification of the authorization to execute the software function includes verifying that the software function is one of the functions of the computer that is authorized for execution.

44. The method according to claim 39, wherein the license proof includes an authenticating signature confirming the authorization to execute the software function.

45. The method according to claim 44, wherein the verification that the license proof indicates the authorization to execute the software function includes verifying that the authenticating signature has been issued by a vendor of the software function.

46. The method according to claim 39, wherein a license managing agent activates a license at a check-out time authorizing the execution of the software function.

47. The method according to claim 46, wherein the check-out time is indicated by a date and time of day according to a selected time zone.

48. The method according to claim 47, wherein the verification that the license proof indicates the authorization to execute the software function includes verifying that an interval of time between a current time and the check-out time is not greater than a threshold value.

49. The method according to claim 48, wherein if the interval of time is greater than or equal to the threshold value, then an error notification is transmitted back to the remote entity.

50. The method according to claim 39, wherein the license proof is received as an encrypted license proof, and the method further comprises: decrypting the encrypted license proof using a shared secret key so as to verify that the encrypted license proof was encrypted with the shared secret key and thereby also verify that the encrypted license proof was sent by the remote entity since the remote entity is substantially the only other entity that knows the shared secret key.

51. The method according to claim 39, wherein the license proof is received as an encrypted license proof, and the method further comprises: decrypting the encrypted license proof using a public key associated with the remote entity so as to verify that the encrypted license proof was encrypted with a private key of the remote entity and thereby also verify that the encrypted license proof was sent by the remote entity since the remote entity is substantially the only entity that knows the private key.

52. An apparatus for confirming that a remote entity has a license to execute a software function comprising a processor configured to: receive a license proof along with a request to execute a software function from a remote entity, and verify that the license proof came from the remote entity and indicates an authorization to execute the software function.

53. The apparatus according to claim 52, wherein the processor is further configured to: execute the software function in response to the request after verifying that the license proof came from the remote entity and indicates the authorization to execute the software function.

54. The apparatus according to claim 53, wherein the processor is further configured to: transmit information resulting from executing the software function to the remote entity.

55. The apparatus according to claim 52, wherein the license proof includes information of which functions of a computer program are authorized for execution.

56. The apparatus according to claim 55, wherein the processor is further configured to verify that the software function is one of the functions of the computer program are authorized for execution.

57. The apparatus according to claim 52, wherein the license proof includes an authenticating signature confirming the authorization to execute the software function.

58. The apparatus according to claim 57, wherein the processor is further configured to: verify that the authenticating signature has been issued by a vendor of the software function.

59. The apparatus according to claim 52, wherein a license authorizing the execution of the software function has been activated by a license managing agent at a check-out time.

60. The apparatus according to claim 59, wherein the check-out time is indicated by a date and time of day according to a selected time zone.

61. The apparatus according to claim 60, wherein the processor is further configured to: verify that an interval of time between a current time and the check-out time is not greater than a threshold value.

62. The apparatus according to claim 61, wherein if the interval of time is greater than or equal to the threshold value, then an error notification is transmitted back to the remote entity.

63. The apparatus according to claim 52, wherein the license proof is received as an encrypted license proof, and the processor is further configured to: decrypt the encrypted license proof using a shared secret key so as to verify that the encrypted license proof was encrypted with the shared secret key and consequently, also verify that the encrypted license proof was sent by the remote entity since the remote entity is substantially the only other entity that knows the shared secret key.

64. The apparatus according to claim 52, wherein the license proof is received as an encrypted license proof, and the processor is further configured to: decrypt the encrypted license proof using a public key associated with the remote entity so as to verify that the encrypted license proof was encrypted with a private key of the remote entity and consequently, also verify that the encrypted license proof was sent by the remote entity since the remote entity is substantially the only entity that knows the private key.

65. A method for executing a software function in a distributed process spanning different process spaces, comprising: executing a first computer program running in a first process space so as to generate a license proof and transmit the license proof along with a request to execute a software function; and executing a second computer program running in a second process space so as to receive the license proof and verify that the license proof was generated by the first computer program and that the license proof includes an authorization to execute the software function.

66. The method according to claim 65, wherein the first process space is a first memory address space associated with a first computer running the first computer program, and the second process space is a second memory address space associated with a second computer running the second computer program.

67. The method according to claim 66, wherein the first computer and the second computer communicate through a firewall protecting the second computer.

68. The method according to claim 65, wherein the license proof includes information copied from a license activated at a check-out time indicating license terms for an application program including the software function.

69. The method according to claim 68, wherein the application program includes at least one other software function in addition to the software function.

70. The method according to claim 68, wherein the information copied from the license includes an authenticating signature indicating the right to execute the software function.

71. The method according to claim 68, wherein the license proof includes a time stamp indicating the check-out time.

72. The method according to claim 71, wherein the execution of the second program verifies that an interval of time between a current time and the check-out time is not greater than a threshold value as part of the verification that the license proof includes the authorization to execute the software function.

73. The method according to claim 72, wherein if the interval of time is greater than or equal to the threshold value, then an error notification is transmitted back to the first computer program.

74. The method according to claim 72, wherein if the interval of time is less than the threshold value, then the method further comprises: executing the second computer program so as to comply with the request to execute the software function utilizing the authorization included in the license proof.

75. The method according to claim 65, wherein the execution of the first computer program encrypts the license proof using an encryption key to generate an encrypted license proof and transmits the encrypted license proof along with the request to execute the software function, and the execution of the second computer program decrypts the received encrypted license proof using a decryption key so as to verify that the license key was generated by the first computer program and facilitate verification that the license proof includes the authorization to execute the software function.

76. The method according to claim 75, wherein the encryption key and the decryption key are both a shared secret key known to the first computer program and the second computer program.

77. The method according to claim 75, wherein the encryption key is a private key associated with the first computer program, and the decryption key is a public key associated with the first computer program.

78. A system for executing a software function in a distributed process spanning different process spaces, comprising: a first computer executing a first computer program running in a first process space so as to generate a license proof and transmit the license proof along with a request to execute a software function; and a second computer executing a second computer program running in a second process space so as to receive the license proof and verify that the license proof was generated by the first computer program and that the license proof includes an authorization to execute the software function.

79. The system according to claim 78, wherein the first process space is a first memory address space associated with the first computer, and the second process space is a second memory address space associated with the second computer.

80. The system according to claim 79, wherein the first computer and the second computer communicate through a firewall protecting the second computer.

81. The system according to claim 78, wherein the license proof includes information copied from a license activated at a check-out time indicating license terms for an application program including the software function.

82. The system according to claim 81, wherein the application program includes at least one other software function in addition to the software function.

83. The system according to claim 81, wherein the information copied from the license includes an authenticating signature indicating the right to execute the software function.

84. The system according to claim 81, wherein the license proof includes a time stamp indicating the check-out time.

85. The system according to claim 84, wherein the execution of the second program verifies that an interval of time between a current time and the check-out time is not greater than a threshold value as part of the verification that the license proof includes the authorization to execute the software function.

86. The system according to claim 85, wherein if the interval of time is greater than or equal to the threshold value, then an error notification is transmitted back to the first computer program.

87. The system according to claim 85, wherein if the interval of time is less than the threshold value, then the method further comprises: executing the second computer program so as to comply with the request to execute the software function utilizing the authorization included in the license proof.

88. The system according to claim 78, wherein the execution of the first computer program encrypts the license proof using an encryption key to generate an encrypted license proof and transmits the encrypted license proof along with the request to execute the software function, and the execution of the second computer program decrypts the received encrypted license proof using a decryption key so as to verify that the license key was generated by the first computer program and facilitate verification that the license proof includes the authorization to execute the software function.

89. The system according to claim 88, wherein the encryption key and the decryption key are both a shared secret key known to the first computer program and the second computer program.

90. The system according to claim 88, wherein the encryption key is a private key associated with the first computer program, and the decryption key is a public key associated with the first computer program.
